(19) United States
(12) Patent Application Publication
(10) Pub. No.: US 2025/0328840 A1
(43) Pub. Date: Oct. 23, 2025

(54) Mobile Calendar View User Interface

(71) Applicant: Hexagon Technology Center GmbH, Heerbrugg (CH)

(72) Inventor: Sydney Claire Baker, Austin, TX (US)

(21) Appl. No.: 18/639,289

(22) Filed: Apr. 18, 2024

(51) Int. Cl. G06Q 10/0633; G06T 11/20

(52) U.S. Cl. CPC G06Q 10/0633; G06T 11/206; G06T 2200/24

(57) ABSTRACT

Illustrative embodiments enhance and improve the efficiency of tracking and managing tasks of a workflow, for example a workflow including a plurality of tasks of a large-scale construction project. Illustrative embodiments improve methods and systems by providing and populating a graphical user interface that makes more efficient use of limited screen space on a computer display while conveying a plurality of status of a corresponding plurality of tasks.

### FIELD

Illustrative embodiments of the invention generally relate to computer systems and, more particularly, various embodiments of the invention relate to filed progressing in large manufacturing projects.

### BACKGROUND

A large-scale manufacturing project typically requires many workflows, where each workflow includes a set of tasks. For example, where the project includes manufacturing an oil refinery, one workflow may include installing one or more high-pressure pipelines for transporting liquids, and a task within the workflow may be to couple one section of flanged pipe to another section of flanged pipe. The point of joinder may be referred-to as a flanged joint. A flanged joint typically consists of a plurality of components that operate together as a system, such as flanges, nuts and that fasten the flanges together, washers, and one or more gaskets.

Over the course of the project, each task is typically subject to a set of inspections by an inspector, such as a project engineer or construction foreman, for example. Such inspections may be periodic, and/or on a pre-determined schedule, and/or or at certain points within the project. In keeping with the flanged joint example, each segment of flanged pipe, including each flange and component is subject to standards that must be met in order to produce the project, and each such component, and its installation, and the flanged joint itself, are subject to a plurality of inspections during the course of manufacturing.

The inspector typically records (or “logs”) in a log file an observation (or “field observation”) based on each inspection.

Each task has a “status” based on a set of observations associated with that task. In keeping with the flanged joint example, a status for the task of coupling one section of flanged pipe to another section of flanged pipe might include (without limitation) “not yet begun,” “pipe sections aligned,” “pipe sections secured in place,” “flanges bolted,” “bolt torque confirmed,” “flanged joint pressure tested,” and “completed,” to name but a few examples.

### SUMMARY OF VARIOUS EMBODIMENTS

Illustrative embodiments enhance and improve the efficiency of tracking and managing tasks of a workflow, for example a workflow including a plurality of tasks of a large-scale construction project. Illustrative embodiments improve methods and systems by providing and populating a graphical user interface that makes more efficient use of limited screen space on a computer display while conveying a plurality of status of a corresponding plurality of tasks.

A first embodiment includes a computer-implemented method of field progressing for a large-scale manufacturing project at a large-scale manufacturing site, the project having a plurality of associated project tasks. The method includes receiving, at a project management platform, a plurality of log files, each log file having a field observation of a project task; determining, from each log file, a status of its associate task, the status being one of a plurality of states and corresponding to an associated date, to produce a plurality of statuses; and forwarding a status message toward a remote user device. The status message has information for populating a graphical user interface on the remote user device, where the graphical user interface has a calendar. The calendar includes (a) a plurality of day indicia, each day indicia uniquely associated with a corresponding date and a set of log files corresponding to said date, said log files being that date's corresponding log files and corresponding to a set of tasks associated with that date, and (b) a plurality of graphic status indicia, each graphic status indicium of the plurality of graphic status indicia: (i) graphically and uniquely associated with a corresponding day indicium from the plurality of day indicia, and (ii) graphically identifying the plurality of statuses, each status of the plurality of statuses corresponding a log file from the date's corresponding log files.

In some embodiments, each day indicia further includes a number to indicate its corresponding date; and the graphic status indicium for each day includes a graphical device adjacent to the number.

In some embodiments, the graphic status indicium for each day includes a graphical device, wherein said graphical device includes an annular device having a plurality of segments, each segment of the plurality of segments associated with a given status, the size of each segment relative to other segments indicating the proportion of tasks, relative to the set of tasks associated with that date, having the given status. In some such embodiments, each day indicium further includes a number to indicate its corresponding date, said number disposed within the annular device.

In some embodiments, the graphic status indicium for each day includes a graphical device, wherein said graphical device includes a circular device having a plurality of pie-shaped segments, each pie-shaped segment of the plurality of segments associated with a given status and the size of each segment relative to other segments indicating the proportion of tasks, relative to the set of tasks associated with that date, having the given status. In some such embodiments, each day indicium further includes a number to indicate its corresponding date, said number superimposed over the graphical device.

In some embodiments, the graphic status indicium for each day includes a graphical device, wherein said graphical device includes a rectangular device having a plurality of rectangular segments, each rectangular segment of the plurality of segments associated with a given status and the size of each segment relative to other segments indicating the proportion of tasks, relative to the set of tasks associated with that date, having the given status. In some such embodiments, each day indicium further includes a number to indicate its corresponding date, said number superimposed over the graphical device.

In some embodiments, the remote user device is a hand-held using device having a computer display screen configured to display the graphical user interface.

Another embodiment includes a computer-implemented system for field progressing for a large-scale manufacturing project at a large-scale manufacturing site, the project having a plurality of associated project tasks. The system includes a project management platform configured to: receive, from a set of operators at the large-scale manufacturing site, a plurality of log files, each log file having a field observation of a project task from the plurality of project tasks of the large-scale manufacturing project; determine, from each log file, a status of its associate task, the status being one of a plurality of states corresponding to an associated date; and generate a status message having information for to populate a graphical user interface on a remote user device. The graphical user interface at the remote user device a has a calendar including: (a) a plurality of day indicia, each day indicia uniquely associated with a corresponding date and a set of log files corresponding to said date, said log files being that date's corresponding log files and corresponding to a set of tasks associated with that date, and (b) a plurality of graphic status indicia. Each such graphic status indicium of the plurality of graphic status indicia: (i) graphically and uniquely associated with a corresponding day indicium from the plurality of day indicia, and (ii) graphically identifying a plurality of statuses, each status of the plurality of statuses corresponding a log file from the date's corresponding log files. The project management platform is also configured to: forward the status message toward the remote user device.

In some system embodiments, the remote user device is a hand-held user device having a computer display screen configured to display the graphical user interface.

In some embodiments, each log file includes status data recording the status of its associate task.

In some embodiments, the graphic status indicium for each day includes a graphical device, wherein said graphical device includes an annular device having a plurality of segments, each segment of the plurality of segments associated with a given status, the size of each segment relative to other segments indicating the proportion of tasks, relative to the set of tasks associated with that date, having the given status. In some such embodiments, each day indicium further includes a number to indicate its corresponding date, said number disposed within the annular device.

In some embodiments, the graphic status indicium for each day includes a graphical device, wherein said graphical device includes a circular device having a plurality of pie-shaped segments, each pie-shaped segment of the plurality of segments associated with a given status and the size of each segment relative to other segments indicating the proportion of tasks, relative to the set of tasks associated with that date, having the given status; and each day indicium further includes a number to indicate its corresponding date, said number superimposed over the graphical device.

In some embodiments, the graphic status indicium for each day includes a graphical device, wherein said graphical device includes a rectangular device having a plurality of rectangular segments, each rectangular segment of the plurality of segments associated with a given status and the size of each segment relative to other segments indicating the proportion of tasks, relative to the set of tasks associated with that date, having the given status; and each day indicium further includes a number to indicate its 15 corresponding date, said number superimposed over the graphical device.

Yet another embodiment includes a non-transitory computer-readable medium having computer executable code thereon, the computer executable code, when executed by a computer system of a project management platform, causing the computer system to perform a method for field progressing for a large-scale manufacturing project at a large-scale manufacturing site, the project having a plurality of associated project tasks. The code includes: code for receiving, at the project management platform, a plurality of log files, each log file having a field observation of a project task; code for determining, from each log file, a status of its associate task, the status being one of a plurality of states corresponding to an associated date; and code for forwarding a status message toward a remote user device, the status message having information for populating a graphical user interface on the remote user device, where the graphical user interface having calendar includes: (a) a plurality of day indicia, each day indicia uniquely associated with a corresponding date and a set of log files corresponding to said date, said log files being that date's corresponding log files and corresponding to a set of tasks corresponding to that date, and (b) a plurality of graphic status indicia, each graphic status indicium of the plurality of graphic status indicia: (i) graphically and uniquely associated with a corresponding day indicium from the plurality of day indicia, and (ii) graphically identifying a plurality of statuses, each status of the plurality of statuses corresponding a log file from the date's corresponding log files.

In some embodiments, the graphic status indicium for each day includes a graphical device, wherein said graphical device includes an annular device having a plurality of segments, each segment of the plurality of segments associated with a given status, the size of each segment relative to other segments indicating the proportion of tasks, relative to the tasks associated with that date, having the given status; and each day indicium further includes a number to indicate its corresponding date, said number disposed within the annular device.

In some embodiments, the graphic status indicium for each day includes a graphical device, wherein said graphical device includes a circular device having a plurality of pie-shaped segments, each pie-shaped segment of the plurality of segments associated with a given status and the size of each segment relative to other segments indicating the proportion of tasks, relative to the tasks associated with that date, having the given status.

In some embodiments, the graphic status indicium for each day includes a graphical device, wherein said graphical device includes a rectangular device having a plurality of rectangular segments, each rectangular segment of the plurality of segments associated with a given status and the size of each segment relative to other segments indicating the proportion of tasks, relative to the tasks associated with that date, having the given status.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Those skilled in the art should more fully appreciate advantages of various embodiments of the invention from the following “Description of Illustrative Embodiments,” discussed with reference to the drawings summarized immediately below.

FIG. 1 schematically illustrates an embodiment of a segment of a large-scale manufacturing project at a large-scale manufacturing site;

FIG. 2A schematically illustrates an embodiment of a system environment;

FIG. 2B schematically illustrates an embodiment of a system;

FIG. 3 is a flowchart of an embodiment of a method;

FIG. 4A schematically illustrates an embodiment of a graphical user interface;

FIG. 4B schematically illustrates an embodiment of a graphical user interface;

FIG. 5A schematically illustrates an embodiment of a graphical device for a graphical user interface;

FIG. 5B schematically illustrates a key for illustrating portions of a graphical device;

FIG. 5C schematically illustrates an embodiment of a graphical device for a graphical user interface;

FIG. 6A schematically illustrates an embodiment of a graphical user interface;

FIG. 6B schematically illustrates an embodiment of a graphical user interface;

FIG. 6C schematically illustrates an embodiment of a graphical user interface;

FIG. 7A schematically illustrates an embodiment of a graphical user interface;

FIG. 7B schematically illustrates an embodiment of a graphical device for a graphical user interface;

FIG. 8 schematically illustrates an embodiment of a graphical device for a graphical user interface.

### DESCRIPTION OF ILLUSTRATIVE EMBODIMENTS

Illustrative embodiments enhance and improve the efficiency of tracking and managing tasks of a workflow, for example a workflow including a plurality of tasks of a large-scale construction project. Illustrative embodiments provide methods and systems that improve conventional methods and systems for displaying statuses of a plurality of workflows or tasks in a large-scale manufacturing project.

Illustrative embodiments improve over prior methods and systems at least in that such embodiments make more efficient use of limited screen space on a computer display screen. Moreover, with illustrative embodiments, a user can instantly know what types of tasks (by status) are available and competing for the user's attention on a given date.

A worker (e.g., an engineer, a construction supervisor; a construction foreman) at a large-scale manufacturing project at a large-scale manufacturing site typically use mobile computing devices. Such mobile computing devices are typically smaller than computers found in an office. Such mobile computing devices typically have a single display screen rather than multi-screen computers in an office, and each such single display screen is smaller than a single screen in an office computer. Consequently, display space (or screen space) on a display screen of a mobile computing device used at a large-scale manufacturing site is at a premium.

Illustrative embodiments described herein improve the use of available display space by conveying more information about the respective statuses of a plurality of tasks, for a plurality of days, than was possible using conventional approaches.

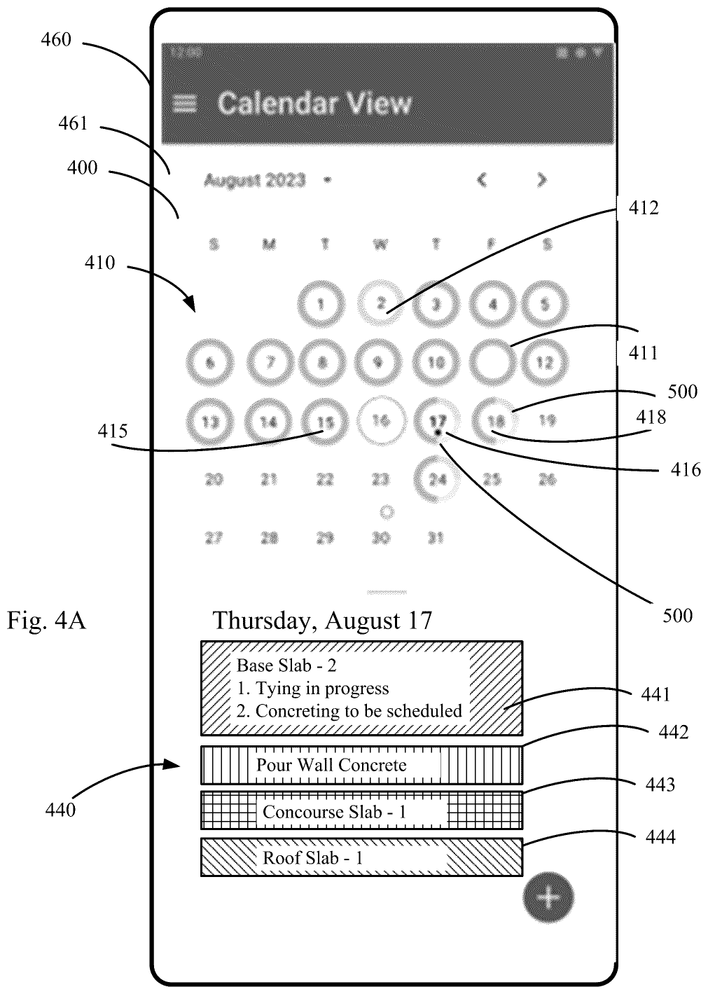

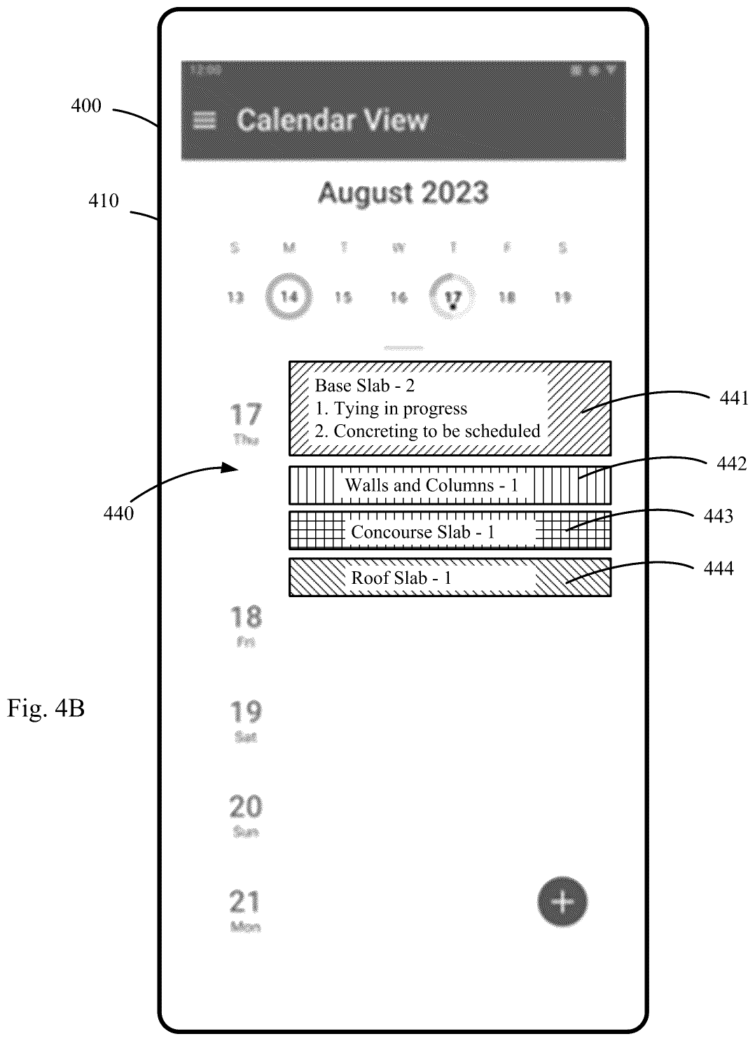

For example, in one embodiment schematically illustrated in FIG. 4A, a graphical user interface 400 displays a calendar 410 showing a plurality of days (or “dates”), each represented by a day indicium (or “date” indicium) 411, 412, 413, 414, 416, 418, each day represented by that day's date within a month. In the embodiment of FIG. 4A, the graphical user interface is displayed on a hand-held user device 460 having a computer display screen 461.

Each day is displayed simultaneously with a graphical element 500 conveying the status of each task of a set of tasks for that day. In illustrative embodiments, the graphical element 500 is adjacent to a date of the day, or the date is displayed over the graphical element.

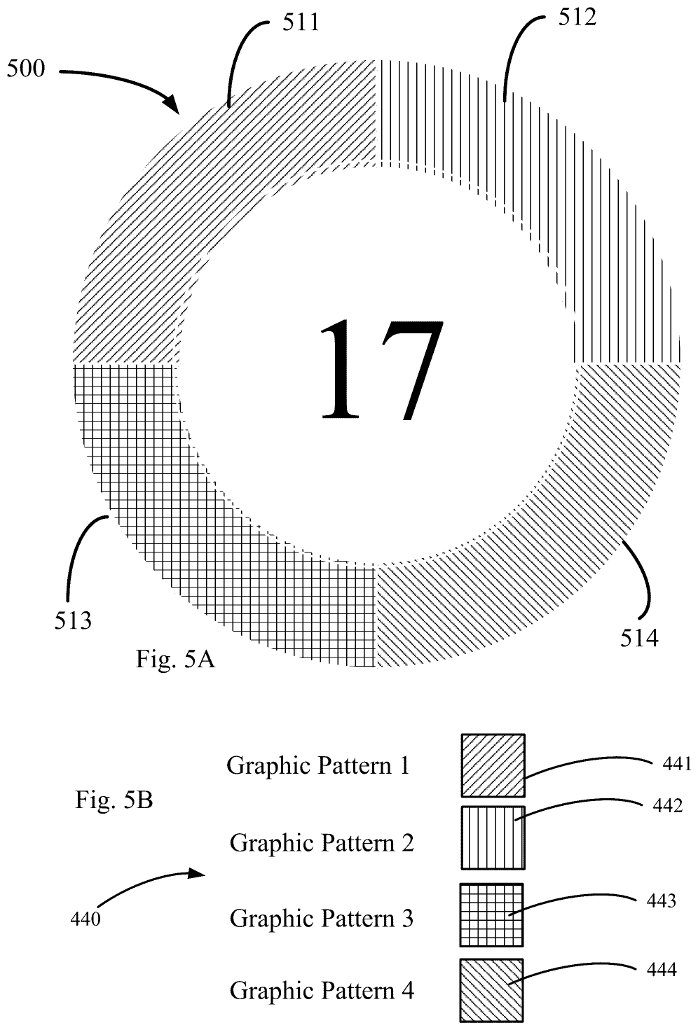

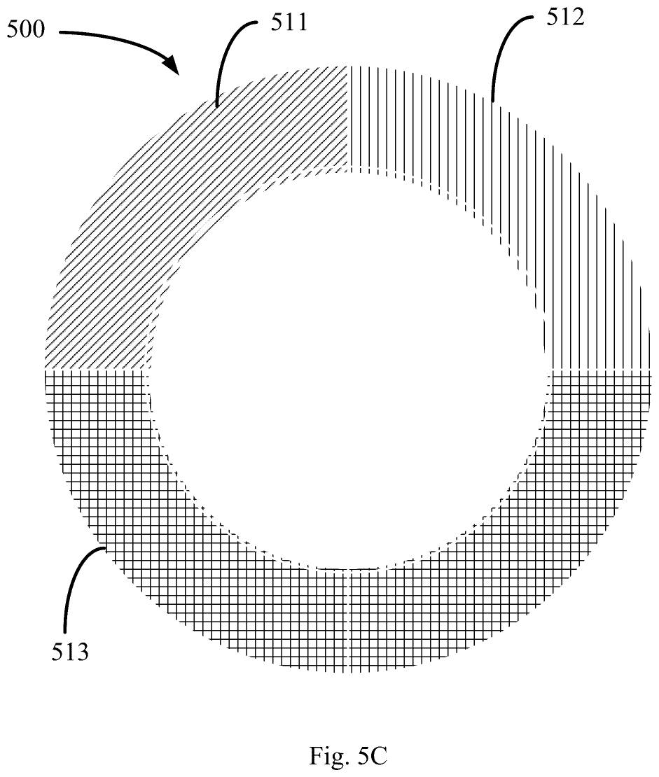

The graphical element 500 in FIG. 4A is in the shape of an annulus (e.g., a donut, or an annular ring) (see, also, FIG. 5A; FIG. 5C) having a plurality of segments 511, 512, 513, 514. Each segment has a unique corresponding graphical style, each graphical style indicating a corresponding status of at least one task for that day.

In some embodiments, a graphical style may be a pattern. In some embodiments, a graphical style may be a solid color field. In some embodiments, a graphical style may be a pattern displayed with an associated color.

Accordingly, for a given day having a set of associated tasks, a user viewing the graphical user interface can tell at a glance which status or statuses apply to the tasks. For example, in FIG. 5A, the graphical element 500 has four segments, 511, 512, 513, 514, each segment having a unique corresponding graphical style, which graphical style is uniquely associated with a status.

In some embodiments, each graphical style may occupy a portion of the annular ring, which portion corresponds to the number of tasks having the status associate with that graphical style relative to the total number of tasks for that day. For example, in FIG. 5A, segment 511 occupies one quarter of (or one fourth of) the annulus, thereby graphically indicating that tasks with the status indicated by the graphical style of segment 511 comprises one quarter of (or one fourth of) the tasks for the date to which the graphical element 500 corresponds. Similarly, each of segments 512, 513 and 514 also occupies a quarter of the annulus, thereby graphically indicating that tasks with the status indicated by the graphical style of segments 512, 513, and 514, respectively, comprise one quarter of (or one fourth of) the tasks for the date to which the graphical element 500 corresponds.

Also for example, in FIG. 5C, each of segments 511 and 512 occupies a quarter of the annulus, thereby graphically indicating that tasks with the status indicated by the graphical style of segments 511 and 512, respectively, comprise one quarter of (or one fourth of) the tasks for the date to which the graphical element 500 corresponds. In contrast, segment 513 occupies one half of the annulus, thereby graphically indicating that tasks with the status indicated by the graphical style of segment 513 comprise one half the tasks for the date to which the graphical element 500 corresponds. In FIG. 5C, there is no segment 514, thereby graphically indicating that there are not tasks for that date that have a status that would be indicated by the graphical style of a segment 514.

Details of illustrative embodiments are discussed below.

Definitions: As used in this description and the accompanying claims, the following terms shall have the meanings indicated, unless the context otherwise requires.

The term “computer-implemented” means implemented with hardware or a combination of hardware and software. Such hardware may include, without limitation, a set of one or more computer processors (e.g., circuits such as a microprocessors, digital signal processors) configured to execute computer-executable code, application specific integrated circuits (“ASICs”), discrete electronic circuits (e.g., transistors), state machine circuits, sequential logic circuits, and/or combinatorial logic circuits, or any combination of the foregoing hardware. Such computer hardware may be in a single computer (e.g., a server), or may be distributed across a plurality of locations over a network (e.g., the “cloud,” as that term is understood in the field of distributed computing).

The term “Field Progressing” means the act, by an observer, of statusing items (e.g., tasks) while the observer is in the field. For example, a field engineer on a construction site might be an observer observing whether a portion of the construction has been completed on a specified date; has used materials specified for that construction; safety violations; general incidents (e.g., necessary construction materials did not arrive on time to be used to meet a task deadline), to name but a few examples.

The term “graphic” in reference to an object to be displayed don a computer display device means that a displayed object is configured to present at least some information in graphical form on a computer display device. Examples of graphical form include, for example and without limiting the scope of the term, an icon that conveys information Display of data in alpha-numeric form (e.g., text) alone is not in a graphic format, even if the alpha-numeric data (e.g., text) is in a table or spreadsheet format.

The term “Observation” means a recorded assessment of an aspect of a task. Such observations may including for example, whether work on the task has been started; whether work on the task has been completed; whether work on, or the result of work on, a task includes an error or other issue to be addressed; and whether the task has been completed. An observation may move through various states as progress on the task continues. An observation may begin with a status of “submitted” (meaning that the observation has been logged, for example in an observation log), and then change to “open” (meaning that an operator or system has recognized, with regard to the task, an issue to address); and “open” observation may generate work to be done and tracked; and then change to “resolved” when the issue has been addressed.

A “set” includes at least one member.

The term “statusing” means to provide an observation pertaining to a task of a workflow, and also includes providing an update to such an observation. An observation of a task may include, for example, a description about the environment of the task; a description about an incident relating to the task; a description of an issue or problem pertaining to the task; a description of progress towards completing the task; a description of changes to the task or to the specification of the task; a description of an incomplete specific step or operation pertaining to the task; and/or a description of a safety incident relating to the task.

The “status” of a task may include a set of observations relating to the task. In illustrative embodiments, such observations are made by a subject matter expert having experience in the field of the task. A status of a task may include “Submitted,” “Approved,” “Draft,” “Rejected,” “Submitted,” “Pending,” “Approved,” “Completed,” “Incomplete,” “Awaiting Approval,” to name but a few examples. Through user input, a task may progress through a life-cycle comprising pre-defined set of statuses between the initial specification of the task and the completion of the task.

A “subset” of a set includes at least one member from the set.

Illustrative embodiments improve the use of screen space on a computer display by a graphical user interface. The improvement is particularly valuable when using a handheld device having a size such as the size of an Apple® iPhone® 15 or a Samsung® Galaxy® S24 (to name but a few examples) where available screen space is less than the screen space on a desktop or laptop computer, for example.

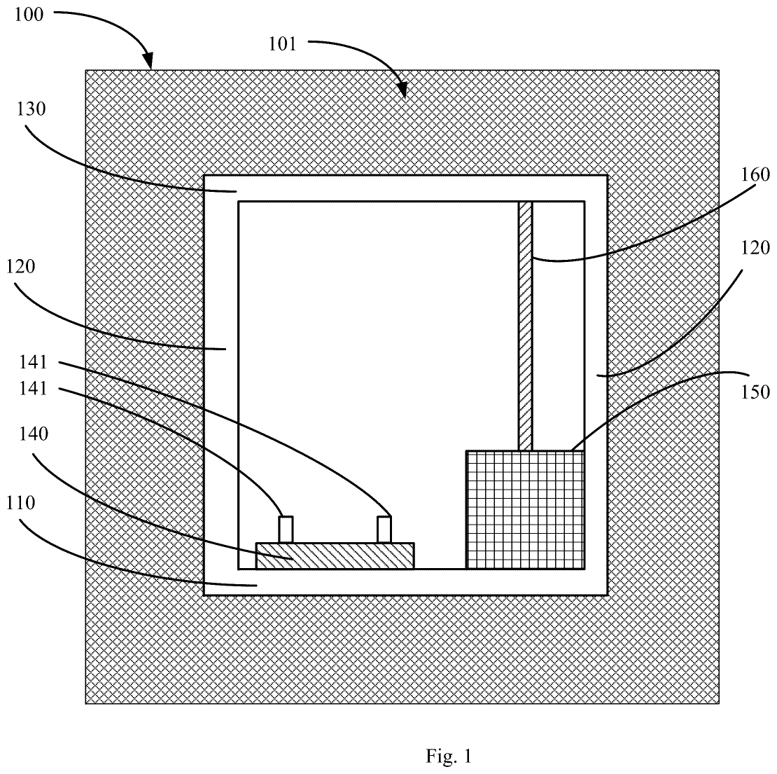

FIG. 1 schematically illustrates an embodiment 100 of a segment of a large-scale manufacturing project at a large-scale manufacturing site. Examples of a large-scale manufacturing project may include constructing a factory or a refinery, or constructing an oil rig or a ship, or an underground subway station, to name but a few examples.

In FIG. 1, the large-scale manufacturing project is an underground subway station having a base slab 110, walls 120, a roof slab 130, a rail bed 140, train rails 141, a passenger platform (or concourse) 150, and a support column 160. The underground subway station is surrounded by rock and soil 101.

A typical large-scale manufacturing project at a large-scale manufacturing site includes a plurality of tasks, wherein each task must be completed using proper materials, proper tools, and in a timely way, and often a task must be begun, worked-on and/or completed in a corresponding position relative to a sequence of tasks for the large-scale manufacturing project. Keeping track of the status of each task is often critical to making sure that the large-scale manufacturing project is completed in a way that is safe and functional.

For example, in the underground subway station of FIG. 1, reinforcement tying of the base slab 110 must be completed; pouring of concrete for the base slab 110 must be completed; shuttering of walls 120 must be completed; pouring of concrete for walls 120 must be completed; walls 120 must be inspected; concrete for the concourse (passenger platform 150) must be poured and cover blocks must be tied; support column 160 must be installed; concrete for the roof slab 130 must be poured; rail bed 140 must be installed; and train rails 141 must be installed and calibrated.

Typically, operations of a manufacturing project at a large-scale manufacturing site must be performed in a fixed order. For example, in keeping with the underground subway station of FIG. 1, a base slab 110 must be completed before concrete 120 walls can be poured, and the concrete walls 120 must be completed before the concourse 150 concrete can be poured, and the roof slab 130 must be complete before the rail bed 140 and rails 141 are installed, to name but a few examples.

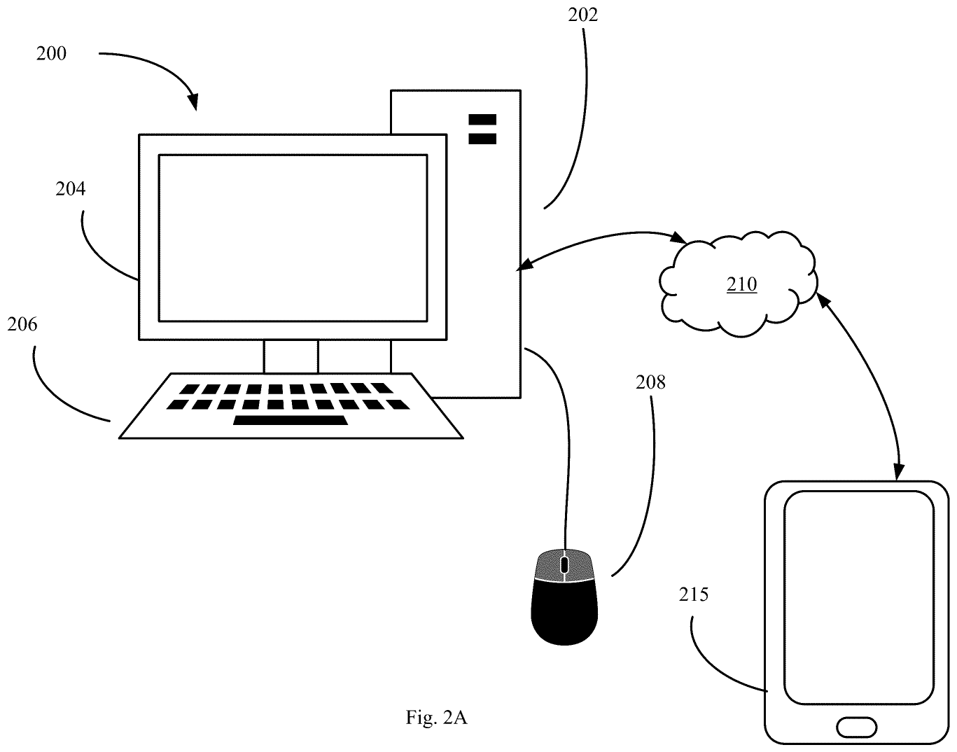

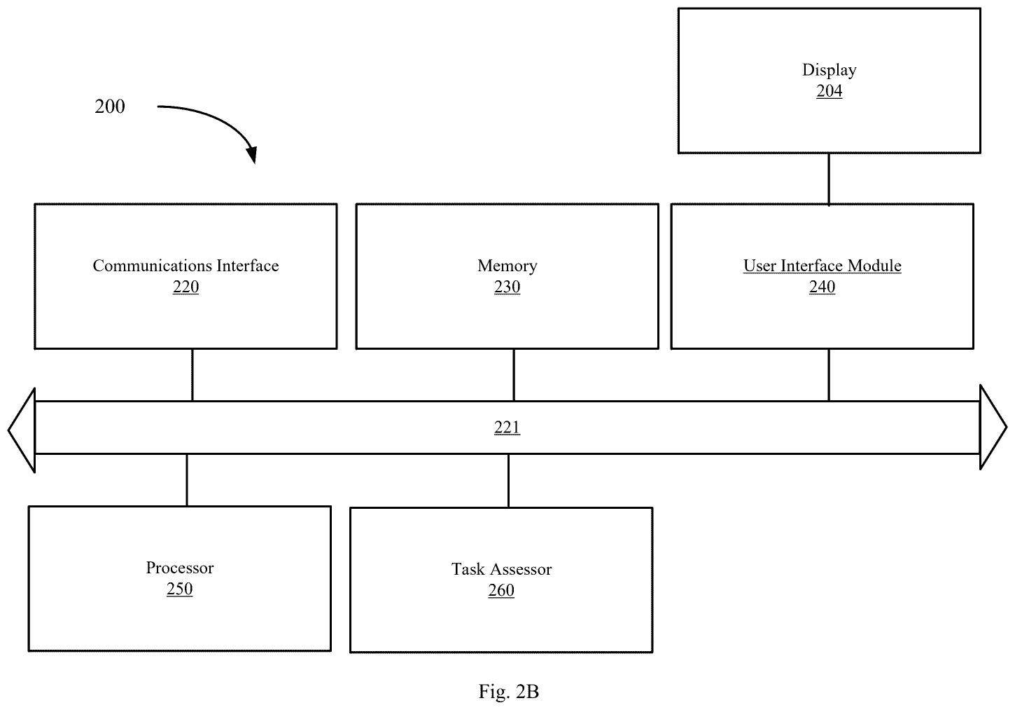

FIG. 2A schematically illustrates an embodiment of a system environment. The environment includes a project management platform 200. In illustrative embodiments, the project management platform 200 has a computer processor 202, a computer monitor 204, a computer keyboard 206, and a computer mouse 208. In FIG. 2A, the project management platform 200 is in data communication with a remote user device 215. In illustrative embodiments, the project management platform 200 is in data communication with a remote user device 215 via a network 210, which may be a cloud or a wide area network, or the Internet, to name but a few examples.

FIG. 2B schematically illustrates an embodiment of a project management platform 200. In the embodiment of FIG. 2B, the project management platform 200 includes a communications interface 220 configured to communicate electronically with devices external to the project management platform 200, a computer memory 230 configured to store data, such as log files, and computer code a processor circuit 250, such as a microprocess from Intel Corporation, and a user interface module 240 configured to generate a graphical user interface, or a status message having information for populating a graphical user interface on a remote device. Some embodiments include a task assessor module configured to assess a status corresponding to an associated task (e.g., by assessing a log file associated with said task).

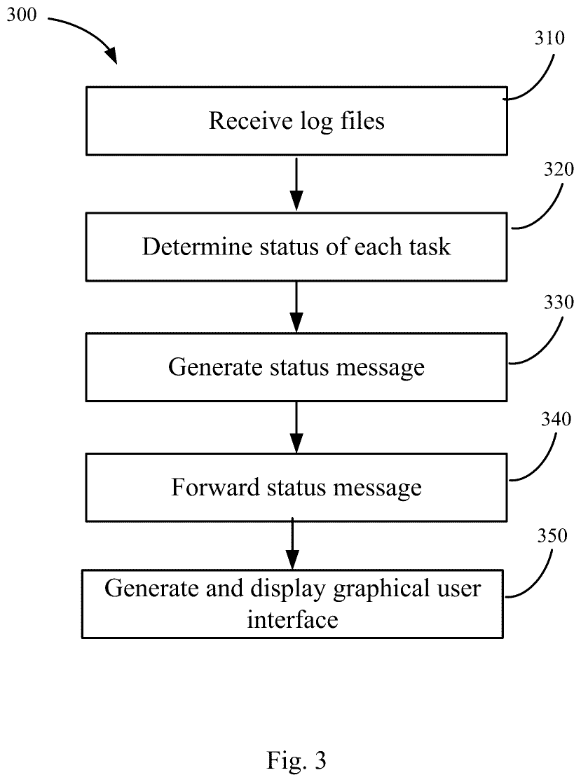

FIG. 3 is a flowchart of an illustrative embodiment of a method 300, such as a method of field progressing for a large-scale manufacturing project at a large-scale manufacturing site, wherein the large-scale manufacturing project has a plurality of associated project tasks.

Step 310 includes receiving, at project management platform 200, a plurality of log files. Each log file has a field observation of a project task, which project task is selected from a plurality of associated project tasks. In some embodiments, each log file incudes status data recording a status of a corresponding project task.

Step 320 includes, subsequent to receiving the plurality of log files for a corresponding plurality of tasks, determining from each log file the status of its corresponding task. In some embodiments, in which each log file incudes status data recording a status of a corresponding project task, step 310 includes reading the status data from each log file.

In some embodiments, step 320 includes determining a status of a task, from a corresponding log file, by assessing data in the log file other than status data that records a status of a corresponding project task. In some embodiments, step 320 includes determining a status of a task, from a corresponding log file, by assessing data in the log file and without assessing status data that records a status of a corresponding project task.

Step 330 includes generating a status message. In illustrative embodiments, each status message includes information for populating a graphical user interface on the remote user device. In illustrative embodiments, the graphical user interface has (and the status message has information to populate) a calendar including (a) a plurality of day indicia, each day indicia uniquely associated with a corresponding date and a set of log files corresponding to said date, said log files being that date's corresponding log files, and (b) a plurality of graphic status indicia, each graphic status indicium of the plurality of graphic status indicia (i) graphically and uniquely associated with a corresponding day indicium from the plurality of day indicia, and (ii) graphically identifying a plurality of statuses, each status of the plurality of statuses corresponding a log file from the date's corresponding log files. The status message includes information necessary to populate the foregoing portions of the graphical user interface.

Step 340 includes forwarding the status message to a remote user device, such that the remote user device can use the information in the status message to populate a graphical user interface as described herein.

Some embodiments include Step 350, which includes generating a graphical user interface from information in the status message, and displaying the graphical user interface to a user, for example on a computer display 204 or a handheld device 215.

FIG. 4A schematically illustrates an embodiment of a graphical user interface 400 in the form of a calendar. In FIG. 4A, the graphical user interface 400 is schematically illustrated as displayed on a handheld device 215, such as a cellular telephone.

In FIG. 4A, the graphical user interface includes a plurality of day indicia (e.g., 411, 412, 413, 414, 416, 418). 400 displays a graphical calendar element 410. In illustrative embodiments, the graphical calendar element 410

Each day indicium of the plurality of day indicia is uniquely associated with a corresponding date and a set of log files corresponding to said date. In FIG. 4A, each day indicium includes a date indicium number indicating the date of the corresponding day. For example, day indicium 411 includes the number “5,” indicating that the corresponding day is the fifth day of the month.

The graphical user interface 400 of FIG. 4A also includes a plurality of graphical status indicia 500. In illustrative embodiment, each date has a corresponding graphical status indicium 500. Each graphic status indicium 500 of the plurality of graphic status indicia is (i) graphically and uniquely associated with a corresponding day indicium from the plurality of day indicia, and (ii) graphically identifies a plurality of statuses, each status of the plurality of statuses corresponding a log file from the date's corresponding log files. In some embodiments, one or more day indicia omit a corresponding date indicium. For example, a day indicium may include a status indicium 500 for a given date, but may omit the number of the given date. Omitting the date indicium leaves more room on the screen display to show other information (e.g., the status indicium), yet a user can still determine the date of the given day by viewing the day indicium in the context of other day indicia in the calendar. For example, from the context of the calendar 410, a user could easily determine that the day indicium 411 represents the eleventh day of the month.

In some embodiments, graphical calendar element 410 includes a key 440 that correlates each graphical style (e.g., 441, 442, 443, 444) of a status indicium 500 to a corresponding status. For example, in some embodiments, such a feature of a status indicium may be a color, such that each color uniquely corresponds to a corresponding status, or a pattern, such that each pattern uniquely corresponds to a corresponding status.

FIG. 4B schematically illustrates an embodiment of a graphical user interface 410 representing a week of days.

FIG. 5A schematically illustrates an embodiment of a status indicium 500 having an annular shape. Such a status indicium 500 may be referred-to as an annulus, or having the shape of an annulus.

The status indicium 500 of includes a plurality of segments, 511, 512, 513, 514. each segment 511, 512, 513, 514 has a corresponding segment indicium (or “graphical style”) uniquely associated with a corresponding status of a set of log files. Such a segment indicium may be a graphical pattern, or a color, or a combination of a graphical pattern and a color. In this way, each log file may be associated with a corresponding, distinct status. FIG. 4A includes a key 400 indicating a color or pattern each uniquely associated with each of a plurality of statuses.

Each status may graphically indicate, to a user, a status of log files or in some embodiments status of construction operations. In this way, the user can quickly understand and identify what log files (or construction operations) need the most immediate attention from the user, and which are less urgent.

In some embodiments, the status of a log file representing a construction operation may be a quantitative specification, which quantitative specification describes a log file or operation in terms of the state of a project operation. For example, a status may be selected from “completed,” “work-in-progress” (or “partially completed”), “inspection pending,” “design approval pending,” and “quality inspection ongoing,” to name but a few examples.

For example, in FIG. 4A, indicium 441 is red (or in some embodiments has a first pattern) and corresponds to a status of “Work-in-Progress;” indicium 442 is orange (or in some embodiments has a second pattern distinct from the first pattern) and corresponds to a status of “Completed;” indicium 443 is yellow (or in some embodiments has a third pattern distinct from both the second pattern and the first pattern), and corresponds to a status of “Inspection Pending;” and indicium 444 is green (or in some embodiments has a fourth pattern that is distinct from the third pattern, the second pattern, and the first pattern) corresponds to a status of “Design Approval Pending.”

In FIG. 4A, status indicium 412 includes a single segment having an orange color, indicating that all tasks associated with indicium 413 have a status of “Work-in-Progress,” and that there are no tasks for that date having a status other than “Work-in-Progress.”

In FIG. 4A, status indicium 415 includes two segments of equal size, one of which is green (indicating a set of tasks having a status of “Design Approval Pending”) and one of which is red (indicating a status of “Completed”). Status indicium 415 indicates that it represents an equal number of tasks for “Design Approval Pending” and “Completed,” because each segment is the same size as each other segment. In other words, the relative sizes of segments of a status indicium 415 graphically indicates to a user the relative proportions of tasks of associated status for the day.

In some embodiments, the status of a log file representing a construction operation may be a qualitative specification, which qualitative specification describes a log file or operation in terms other than a quantitative specification. For example, a status may be selected from “Urgent,” “Pending,” “Needs Attention,” and “Planning Stage” to name but a few examples.

For example, in some embodiments, the status of a log file (or construction operation) may, for example, derive (or be derived from) from or be dictated by the order in which construction operations must be performed, at step 320 of the method described above. For example, if a first operation must be completed before a second operation (e.g., the base slab 110 must be completed before walls 120 are poured), then the first operation (e.g., pouring the base slab 110) will have higher urgency than then the second operation (e.g., pouring the walls 120).

For example, in FIG. 4A, indicium 441 is red (or in some embodiments has a first pattern) and corresponds to a status of “Urgent;” indicium 442 is orange (or in some embodiments has a second pattern distinct from the first pattern) and corresponds to a status of “Pending;” indicium 443 is yellow (or in some embodiments has a third pattern distinct from both the second pattern and the first pattern), and corresponds to a status of “Needs Attention;” and indicium 444 is green (or in some embodiments has a fourth pattern that is distinct from the third pattern, the second pattern, and the first pattern) corresponds to a status of “Planning Stage.”

In FIG. 4A, status indicium 412 includes a single segment having an orange color, indicating that all tasks associated with indicium 413 have a status of “Pending,” and that there are no tasks for that date having a status other than “Pending.”

In FIG. 4A, status indicium 415 includes two segments of equal size, one of which is green (indicating a set of tasks having a status of “Planning Stage”) and one of which is red (indicating a status of “Urgent”). Status indicium 415 indicates that it represents an equal number of tasks for “Planning Stage” and “Urgent,” because each segment is the same size as each other segment. In other words, the relative sizes of segments of a status indicium 415 graphically indicates to a user the relative proportions of tasks of associated status for the day.

FIG. 5B schematically illustrates a key for segment indicia. Each segment indicium 511, 512, 513, 514 may have a corresponding pattern, and/or a corresponding color.

For example, in FIG. 5B, a first indicium 441 is schematically illustrated in graphic pattern 1, which is uniquely associated with a corresponding first status. In FIG. 5B, graphic pattern 1 comprises spaced lines rising at an angle from lower left to upper right.

A second indicium 442 is schematically illustrated in graphic pattern 2, which is uniquely associated with a corresponding second status. In FIG. 5B, graphic pattern 2 comprises spaced vertical lines.

A third indicium 443 is schematically illustrated in graphic pattern 3, which is uniquely associated with a corresponding third status. In FIG. 5B, graphic pattern 3 comprises a plurality of squares, or a checkerboard pattern.

A fourth indicium 442 is schematically illustrated in graphic pattern 4, which is uniquely associated with a corresponding fourth status. In FIG. 5B, graphic pattern 4 comprises spaced lines rising at an angle from lower right to upper left.

Each graphical pattern 441, 442, 443, 444 is graphically distinguishable from the others.

Each segment corresponds to a set of tasks associated with the date to which the status indicium 500 corresponds. For example, segment 511 indicates that the corresponding date has a set of tasks (each task having an associated log file) having a first status, as indicated by its graphic pattern (Pattern 1, 441). Segment 512 indicates that the corresponding date has a set of tasks (each task having an associated log file) having a second status, as indicated by its graphic pattern (Pattern 2, 442).

Segment 513 indicates that the corresponding date has a set of tasks (each task having an associated log file) having a third status, as indicated by its graphic pattern (Pattern 3, 443).

Segment 514 indicates that the corresponding date has a set of tasks (each task having an associated log file) having a fourth status, as indicated by its graphic pattern (Pattern 4, 444).

By viewing the status indicium 500, a user instantly knows what types of tasks (by status) are available and competing for the user's attention that day. This is an improvement over prior art user interfaces, in which an indicium might, at best, indicate that there is something on that day.

In some embodiments, the size of each segment (e.g., 511, 512, 513, 514) relative to other segments indicates the proportion of tasks, relative to the tasks associated with that date, having the given status. For example, FIG. 5C schematically illustrates a graphical status indicium 500 having three segments: 511, 512, and 513. As schematically illustrated in FIG. 5C, segment 511 occupies a quarter of the annulus, indicating that tasks having status associated with pattern 441 include one quarter of the tasks for the associated date. Similarly, segment 512 occupies a quarter of the annulus, indicating that tasks having status associated with pattern 442 include one quarter of the tasks for the associated date. In contrast, segment 513 occupies a half of the annulus, indicating that tasks having status associated with pattern 443 include one half of the tasks for the associated date.

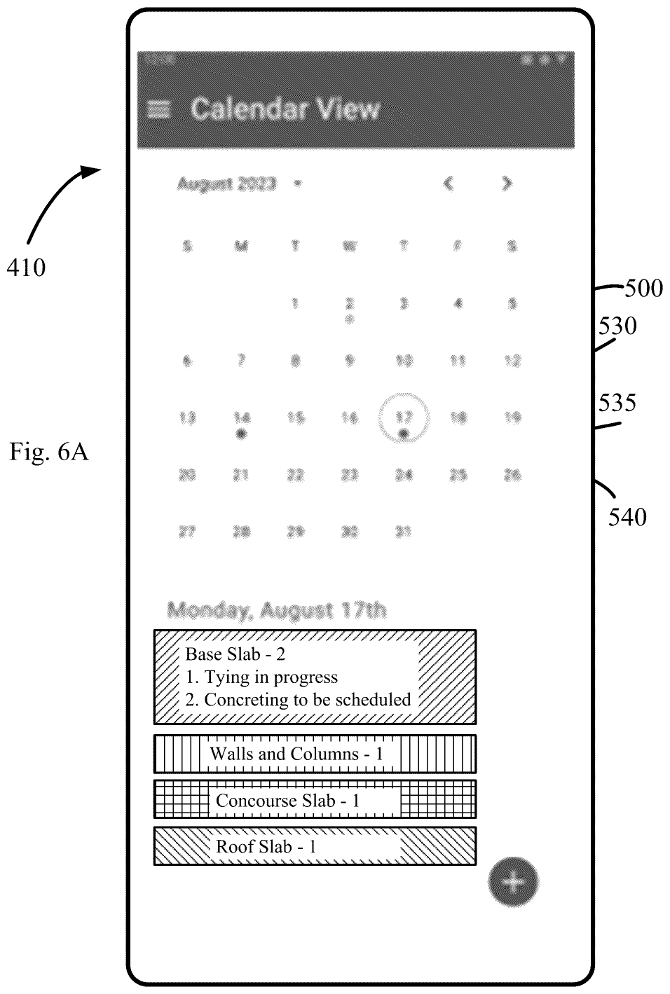

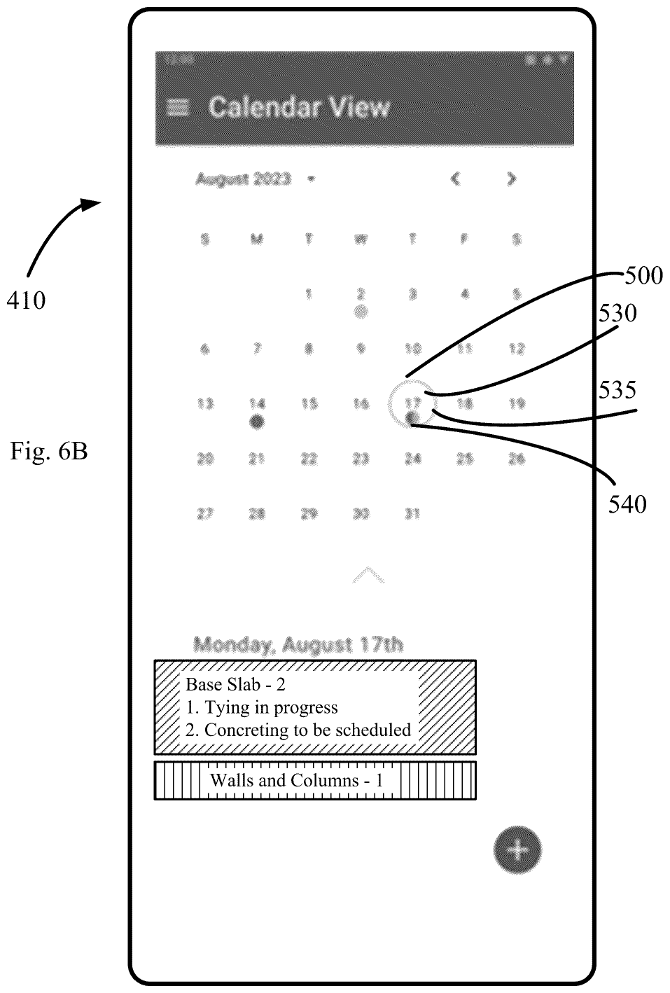

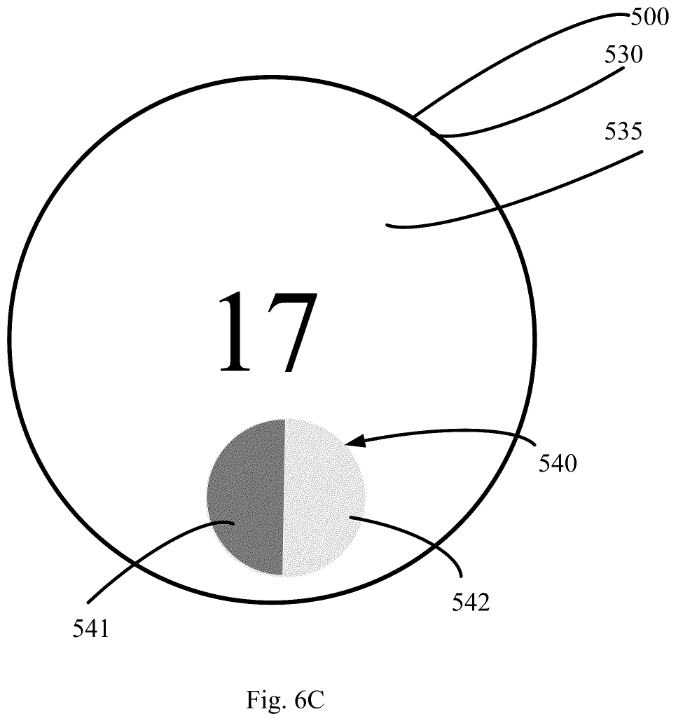

FIG. 6A and FIG. 6B and FIG. 6C each schematically illustrates an embodiment of a graphical user interface in which each graphical device 500 comprises a ring or annulus 530 defining an interior space 535. The graphical device includes, within its interior space 535, a dot 540 having a set of segments. Each segment 545, 542 of the dot 540 is uniquely associated with a corresponding status.

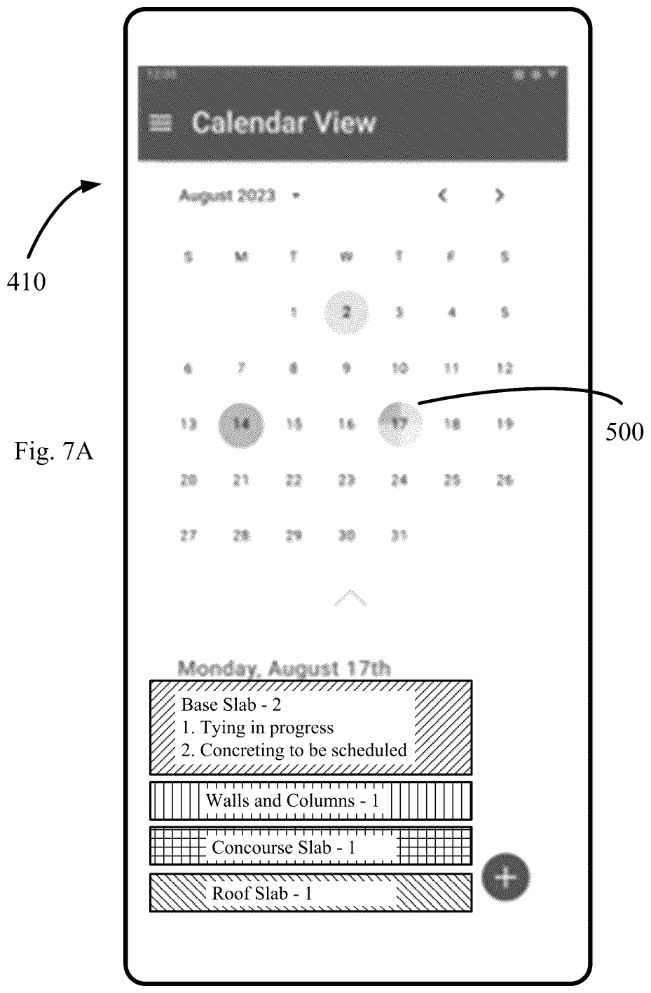

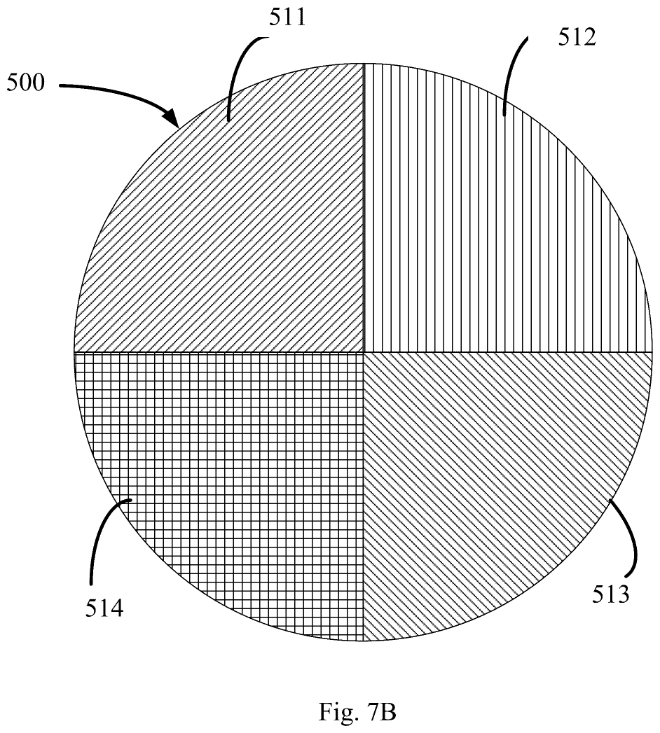

FIG. 7A schematically illustrates an embodiment of a graphical user interface in which each graphical device comprises a circular device (e.g., a circle) having a plurality of pie-shaped segments 511, 512, 513, 514.

FIG. 7B schematically illustrates an embodiment of a graphical device 500 for a graphical user interface in which the graphical device comprises a circle device having a plurality of pie-shaped segments 511, 512, 513, 514. Each pie-shaped segment 511, 512, 513, 514 of the plurality of segments is associated with a given status. In illustrative embodiments, the size of each segment 511, 512, 513, 514 relative to other segments in the graphical device 500 indicates the proportion of tasks, relative to the tasks associated with that date, having the given status. In some embodiments, the graphical device 500 includes a number to indicate its corresponding date, said number superimposed over the graphical device 500 such that the number is surrounded by portions of the graphical device 500.

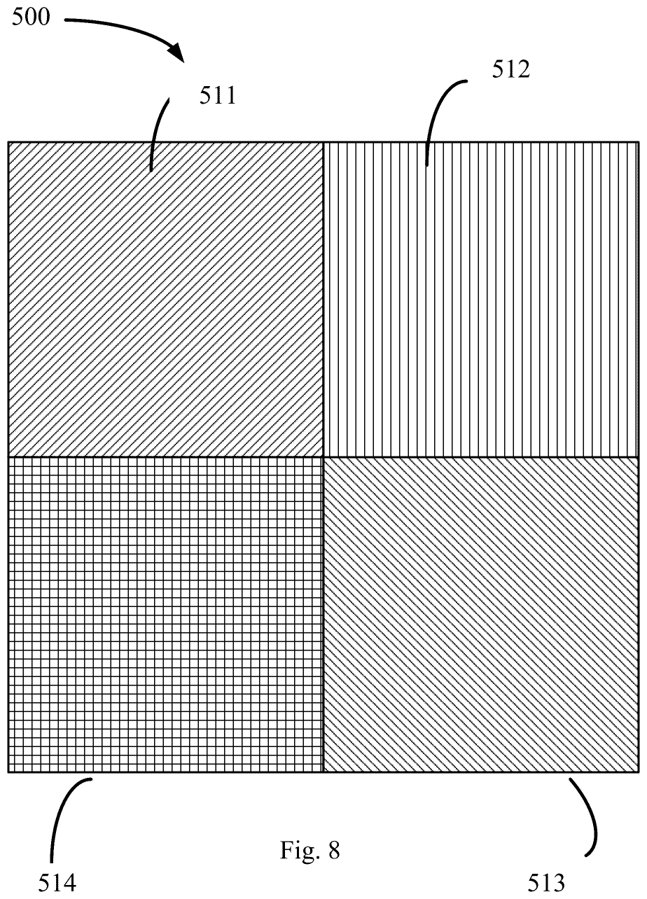

FIG. 8 schematically illustrates an embodiment of a graphical device 500 for a graphical user interface in which the graphical device comprises a rectangular or square device having a plurality of square or rectangular segments 511, 512, 513, 514. Each segment 511, 512, 513, 514 of the plurality of segments is associated with a given status. In illustrative embodiments, the size of each segment 511, 512, 513, 514 relative to other segments in the graphical device 500 indicates the proportion of tasks, relative to the tasks associated with that date, having the given status. In some embodiments, the graphical device 500 includes a number to indicate its corresponding date, said number superimposed over the graphical device.

A listing of certain reference numbers is presented below.
100: Large-scale manufacturing project;
200: System;
202: Central processing unit;
204: Computer display (with screen);
206: Computer keyboard;
208: Computer mouse;
210: Computer network;
215: User device;
220: Communications interface;
230: Computer memory;
240: User interface module;
250: Computer processor;
260: Tack assessor module;
400: Graphical user interface;
410: Calendar element;
411, 412, 413, 414, 416, 418: Day (or “date”) indicia;
415: Status indicium;
440: Key;
441: First graphical style;
442: Second graphical style;
443: Third graphical style;
444: Fourth graphical style;
460: Hand-held user device;
461: Display screen of handheld user device;
500: Graphical status indicium;
511: First segment of graphical status indicium;
512: Second segment of graphical status indicium;
513: Third segment of graphical status indicium;
514: Fourth segment of graphical status indicium;
530: Ring;
535: Interior area of ring;
540: Graphical dot;
541: First segment of graphical dot;
542: Second segment of graphical dot.

Various embodiments may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:

P1. A computer-implemented method of field processing for a large-scale manufacturing project at a large-scale manufacturing site, the method comprising:
receiving, at a project management platform, a plurality of log files, each log file having field observations from the large-scale manufacturing site, the project management platform having a graphical user interface;
determining the status of each of the log files, the status being one of a plurality of states; and
forwarding a status message toward a remote user having access to the project management platform graphical user interface, the status message having information for populating the graphical user interface with a month view, each of a plurality of the days in the month view having associated indicia identifying the status(es) of log file(s) for that day.

P2. The method of P1, the message also having summary indicia identifying the total status(es) for the month for the log files.

P11: A computer-implemented graphical user interface comprising:
a calendar displayed on a user display screen, the calendar comprising a plurality of day icons corresponding to days in a time period, each day having a corresponding set of associated tasks;
a plurality of status indicia, each indicum of the plurality of indica associated with a corresponding day icon from the plurality of day icons, each status indium configured to graphically communicate the status of each task of its corresponding day.

P12: The graphical user interface of P11, wherein the graphical user interface does not display the tasks associated with each day.

P21: A computer-implemented method of field progressing for a large-scale manufacturing project at a large-scale manufacturing site, the project having a plurality of associated project tasks, the method comprising:
receiving, at a project management platform, a plurality of log files, each log file having a field observation of a project task;
determining, by the project management platform, from each log file, a status of its associate project task, the status being one of a plurality of states and corresponding to an associated date, to produce a plurality of statuses; and
forwarding, from the project management platform, a status message toward a remote user device, the status message having information indicating the plurality of statuses for populating a graphical user interface on the remote user device, the graphical user interface including a calendar comprising:
   (a) a plurality of day indicia, each day indicia uniquely associated with a corresponding date and a set of log files corresponding to said date, said log files being that date's corresponding log files and corresponding to a set of project tasks associated with that date, and
   (b) a plurality of graphic status indicia, each graphic status indicium of the plurality of graphic status indicia:
      (i) graphically and uniquely associated with a corresponding day indicium from the plurality of day indicia, and
      (ii) graphically identifying the plurality of statuses, each status of the plurality of statuses corresponding a log file from the date's corresponding log files.

P22. The method of P21, wherein:
each day indicia further comprises a number to indicate its corresponding date; and
the graphic status indicium for each day comprises a graphical device adjacent to the number.

P23. The method of any of P21-P22, wherein:
the graphic status indicium for each day comprises a graphical device, wherein said graphical device comprises an annular device having a plurality of segments, each segment of the plurality of segments associated with a given status, the size of each segment relative to other segments indicating the proportion of tasks, relative to the set of tasks associated with that date, having the given status.

P24. The method of P23, wherein each day indicium further comprises a number to indicate its corresponding date, said number disposed within the annular device.

P25. The method of any of P21-P24, wherein:
the graphic status indicium for each day comprises a graphical device, wherein said graphical device comprises a circular device having a plurality of pie-shaped segments, each pie-shaped segment of the plurality of segments associated with a given status and the size of each segment relative to other segments indicating the proportion of tasks, relative to the set of tasks associated with that date, having the given status.

P26. The method of P25, wherein each day indicium further comprises a number to indicate its corresponding date, said number superimposed over the graphical device.

P27. The method of any of P21-P26, wherein:
the graphic status indicium for each day comprises a graphical device, wherein said graphical device comprises a rectangular device having a plurality of rectangular segments, each rectangular segment of the plurality of segments associated with a given status and the size of each segment relative to other segments indicating the proportion of tasks, relative to the set of tasks associated with that date, having the given status.

P28. The method of P27, wherein each day indicium further comprises a number to indicate its corresponding date, said number superimposed over the graphical device.

P29. The method of any of P21-P28, wherein the remote user device is a hand-held using device having a computer display screen configured to display the graphical user interface.

P30: The method of any of P21-P29, wherein the status of each associated project task comprises a qualitative description of the associated project task.

P31: The method of any of P21-P29, wherein the status of each associated project task comprises a quantitative description of the associated project task.

P40. A computer-implemented system for field progressing for a large-scale manufacturing project at a large-scale manufacturing site, the project having a plurality of associated project tasks, the system comprising:
a project management platform configured to:
   receive, from a set of operators at the large-scale manufacturing site, a plurality of log files, each log file having a field observation of a project task from the plurality of project tasks of the large-scale manufacturing project;
   determine, from each log file, a status of its associate task, the status being one of a plurality of states corresponding to an associated date; and
   generate a status message having information for to populate a graphical user interface on a remote user device, the graphical user interface at the remote user device a having calendar comprising:
      (a) a plurality of day indicia, each day indicia uniquely associated with a corresponding date and a set of log files corresponding to said date, said log files being that date's corresponding log files and corresponding to a set of tasks associated with that date, and
      (b) a plurality of graphic status indicia, each graphic status indicium of the plurality of graphic status indicia:
         (i) graphically and uniquely associated with a corresponding day indicium from the plurality of day indicia, and
         (ii) graphically identifying a plurality of statuses, each status of the plurality of statuses corresponding a log file from the date's corresponding log files; and to forward the status message toward the remote user device.

P41. The system of P40, wherein the remote user device is a hand-held user device having a computer display screen configured to display the graphical user interface.

P42. The system of any of P40-P41, wherein each log file includes status data recording the status of its associate task.

P43. The system of any of P40-P42, wherein the graphic status indicium for each day comprises a graphical device, wherein said graphical device comprises an annular device having a plurality of segments, each segment of the plurality of segments associated with a given status, the size of each segment relative to other segments indicating the proportion of tasks, relative to the set of tasks associated with that date, having the given status.

P44. The system of P43, wherein each day indicium further comprises a number to indicate its corresponding date, said number disposed within the annular device.

P45. The system of any of P40-P44, wherein:
the graphic status indicium for each day comprises a graphical device, wherein said graphical device comprises a circular device having a plurality of pie-shaped segments, each pie-shaped segment of the plurality of segments associated with a given status and the size of each segment relative to other segments indicating the proportion of tasks, relative to the set of tasks associated with that date, having the given status; and wherein
each day indicium further comprises a number to indicate its corresponding date, said number superimposed over the graphical device.

P46. The system of any of P40-P45, wherein:
the graphic status indicium for each day comprises a graphical device, wherein said graphical device comprises a rectangular device having a plurality of rectangular segments, each rectangular segment of the plurality of segments associated with a given status and the size of each segment relative to other segments indicating the proportion of tasks, relative to the set of tasks associated with that date, having the given status; and wherein
each day indicium further comprises a number to indicate its corresponding date, said number superimposed over the graphical device.

P51. A non-transitory computer-readable medium having computer executable code thereon, the computer executable code, when executed by a computer system of a project management platform, causing the computer system to perform a method for field progressing for a large-scale manufacturing project at a large-scale manufacturing site, the project having a plurality of associated project tasks, the code comprising:
code for receiving, at the project management platform, a plurality of log files, each log file having a field observation of a project task;
code for determining, from each log file, a status of its associate task, the status being one of a plurality of states corresponding to an associated date; and
code for forwarding a status message toward a remote user device, the status message having information for populating a graphical user interface on the remote user device, the graphical user interface having calendar comprising:
   (a) a plurality of day indicia, each day indicia uniquely associated with a corresponding date and a set of log files corresponding to said date, said log files being that date's corresponding log files and corresponding to a set of tasks corresponding to that date, and
   (b) a plurality of graphic status indicia, each graphic status indicium of the plurality of graphic status indicia:
      (i) graphically and uniquely associated with a corresponding day indicium from the plurality of day indicia, and
      (ii) graphically identifying a plurality of statuses, each status of the plurality of statuses corresponding a log file from the date's corresponding log files.

P52. The non-transitory computer-readable medium of P51, wherein:
the graphic status indicium for each day comprises a graphical device, wherein said graphical device comprises an annular device having a plurality of segments, each segment of the plurality of segments associated with a given status, the size of each segment relative to other segments indicating the proportion of tasks, relative to the tasks associated with that date, having the given status; and wherein
each day indicium further comprises a number to indicate its corresponding date, said number disposed within the annular device.

P53. The non-transitory computer-readable medium of any of P51-P52,
the graphic status indicium for each day comprises a graphical device, wherein said graphical device comprises a circular device having a plurality of pie-shaped segments, each pie-shaped segment of the plurality of segments associated with a given status and the size of each segment relative to other segments indicating the proportion of tasks, relative to the tasks associated with that date, having the given status.

P54. The non-transitory computer-readable medium of any of P51-P53, wherein:
the graphic status indicium for each day comprises a graphical device, wherein said graphical device comprises a rectangular device having a plurality of rectangular segments, each rectangular segment of the plurality of segments associated with a given status and the size of each segment relative to other segments indicating the proportion of tasks, relative to the tasks associated with that date, having the given status.

P61. A non-transitory computer-readable medium having computer executable code thereon, the computer executable code, when executed by a computer system of a project management platform, causing the computer system to perform a method according to any of P21-P31.

Various embodiments of this disclosure may be implemented at least in part in any conventional computer programming language. For example, some embodiments may be implemented in a procedural programming language (e.g., “C”), or in an object-oriented programming language (e.g., “C++”), or in Python, R, Java, LISP or Prolog. Other embodiments of this disclosure may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed either on a tangible medium, such as a non-transitory computer readable medium (e.g., a diskette, CD-ROM, ROM, FLASH memory, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of this disclosure may be implemented as a combination of both software (e.g., a computer program product) and hardware. Still other embodiments of this disclosure are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads.

The embodiments of the invention described above are intended to be merely exemplary; numerous variations and modifications will be apparent to those skilled in the art. Such variations and modifications are intended to be within the scope of the present invention as defined by any of the appended claims.

What is claimed is:

1. A computer-implemented method of field progressing for a large-scale manufacturing project at a large-scale manufacturing site, the project having a plurality of associated project tasks, the method comprising:
receiving, at a project management platform, a plurality of log files, each log file having a field observation of a project task;
determining, from each log file, a status of its associate project task, the status being one of a plurality of states and corresponding to an associated date, to produce a plurality of statuses; and
forwarding a status message toward a remote user device, the status message having information indicating the plurality of statuses for populating a graphical user interface on the remote user device, the graphical user interface including a calendar comprising:
(a) a plurality of day indicia, each day indicia uniquely associated with a corresponding date and a set of log files corresponding to said date, said log files being that date's corresponding log files and corresponding to a set of project tasks associated with that date, and
(b) a plurality of graphic status indicia, each graphic status indicium of the plurality of graphic status indicia:
(i) graphically and uniquely associated with a corresponding day indicium from the plurality of day indicia, and
(ii) graphically identifying the plurality of statuses, each status of the plurality of statuses corresponding a log file from the date's corresponding log files.

2. The method of claim 1, wherein:
each day indicia further comprises a number to indicate its corresponding date; and
the graphic status indicium for each day comprises a graphical device adjacent to the number.

3. The method of claim 1, wherein:
the graphic status indicium for each day comprises a graphical device, wherein said graphical device comprises an annular device having a plurality of segments, each segment of the plurality of segments associated with a given status, the size of each segment relative to other segments indicating the proportion of tasks, relative to the set of tasks associated with that date, having the given status.

4. The method of claim 3, wherein each day indicium further comprises a number to indicate its corresponding date, said number disposed within the annular device.

5. The method of claim 1, wherein:
the graphic status indicium for each day comprises a graphical device, wherein said graphical device comprises a circular device having a plurality of pie-shaped segments, each pie-shaped segment of the plurality of segments associated with a given status and the size of each segment relative to other segments indicating the proportion of tasks, relative to the set of tasks associated with that date, having the given status.

6. The method of claim 5, wherein each day indicium further comprises a number to indicate its corresponding date, said number superimposed over the graphical device.

7. The method of claim 1, wherein:
the graphic status indicium for each day comprises a graphical device, wherein said graphical device comprises a rectangular device having a plurality of rectangular segments, each rectangular segment of the plurality of segments associated with a given status and the size of each segment relative to other segments indicating the proportion of tasks, relative to the set of tasks associated with that date, having the given status.

8. The method of claim 7, wherein each day indicium further comprises a number to indicate its corresponding date, said number superimposed over the graphical device.

9. The method of claim 1, wherein the remote user device is a hand-held using device having a computer display screen configured to display the graphical user interface.

10. A computer-implemented system for field progressing for a large-scale manufacturing project at a large-scale manufacturing site, the project having a plurality of associated project tasks, the system comprising:
a project management platform configured to:
receive, from a set of operators at the large-scale manufacturing site, a plurality of log files, each log file having a field observation of a project task from the plurality of project tasks of the large-scale manufacturing project;
determine, from each log file, a status of its associate task, the status being one of a plurality of states corresponding to an associated date; and
generate a status message having information for to populate a graphical user interface on a remote user device, the graphical user interface at the remote user device a having calendar comprising:
(a) a plurality of day indicia, each day indicia uniquely associated with a corresponding date and a set of log files corresponding to said date, said log files being that date's corresponding log files and corresponding to a set of tasks associated with that date, and
(b) a plurality of graphic status indicia, each graphic status indicium of the plurality of graphic status indicia:
(i) graphically and uniquely associated with a corresponding day indicium from the plurality of day indicia, and
(ii) graphically identifying a plurality of statuses, each status of the plurality of statuses corresponding a log file from the date's corresponding log files; and to
forward the status message toward the remote user device.

11. The system of claim 10, wherein the remote user device is a hand-held user device having a computer display screen configured to display the graphical user interface.

12. The system of claim 10, wherein each log file includes status data recording the status of its associate task.

13. The system of claim 10, wherein the graphic status indicium for each day comprises a graphical device, wherein said graphical device comprises an annular device having a plurality of segments, each segment of the plurality of segments associated with a given status, the size of each segment relative to other segments indicating the proportion of tasks, relative to the set of tasks associated with that date, having the given status.

14. The system of claim 13, wherein each day indicium further comprises a number to indicate its corresponding date, said number disposed within the annular device.

15. The system of claim 10, wherein:
the graphic status indicium for each day comprises a graphical device, wherein said graphical device comprises a circular device having a plurality of pie-shaped segments, each pie-shaped segment of the plurality of segments associated with a given status and the size of each segment relative to other segments indicating the proportion of tasks, relative to the set of tasks associated with that date, having the given status; and wherein
each day indicium further comprises a number to indicate its corresponding date, said number superimposed over the graphical device.

16. The system of claim 10, wherein:
the graphic status indicium for each day comprises a graphical device, wherein said graphical device comprises a rectangular device having a plurality of rectangular segments, each rectangular segment of the plurality of segments associated with a given status and the size of each segment relative to other segments indicating the proportion of tasks, relative to the set of tasks associated with that date, having the given status; and wherein
each day indicium further comprises a number to indicate its corresponding date, said number superimposed over the graphical device.

17. A non-transitory computer-readable medium having computer executable code thereon, the computer executable code, when executed by a computer system of a project management platform, causing the computer system to perform a method for field progressing for a large-scale manufacturing project at a large-scale manufacturing site, the project having a plurality of associated project tasks, the code comprising:
code for receiving, at the project management platform, a plurality of log files, each log file having a field observation of a project task;
code for determining, from each log file, a status of its associate task, the status being one of a plurality of states corresponding to an associated date; and
code for forwarding a status message toward a remote user device, the status message having information for populating a graphical user interface on the remote user device, the graphical user interface having calendar comprising:
(a) a plurality of day indicia, each day indicia uniquely associated with a corresponding date and a set of log files corresponding to said date, said log files being that date's corresponding log files and corresponding to a set of tasks corresponding to that date, and
(b) a plurality of graphic status indicia, each graphic status indicium of the plurality of graphic status indicia:
(i) graphically and uniquely associated with a corresponding day indicium from the plurality of day indicia, and
(ii) graphically identifying a plurality of statuses, each status of the plurality of statuses corresponding a log file from the date's corresponding log files.

18. The non-transitory computer-readable medium of claim 17, wherein:
the graphic status indicium for each day comprises a graphical device, wherein said graphical device comprises an annular device having a plurality of segments, each segment of the plurality of segments associated with a given status, the size of each segment relative to other segments indicating the proportion of tasks, relative to the tasks associated with that date, having the given status; and wherein
each day indicium further comprises a number to indicate its corresponding date, said number disposed within the annular device.

19. The non-transitory computer-readable medium of claim 17,
the graphic status indicium for each day comprises a graphical device, wherein said graphical device comprises a circular device having a plurality of pie-shaped segments, each pie-shaped segment of the plurality of segments associated with a given status and the size of each segment relative to other segments indicating the proportion of tasks, relative to the tasks associated with that date, having the given status.

20. The non-transitory computer-readable medium of claim 17, wherein:
the graphic status indicium for each day comprises a graphical device, wherein said graphical device comprises a rectangular device having a plurality of rectangular segments, each rectangular segment of the plurality of segments associated with a given status and the size of each segment relative to other segments indicating the proportion of tasks, relative to the tasks associated with that date, having the given status.
